(19) United States
(12) Patent Application Publication
(10) Pub. No.: US 2006/0200352 A1
(43) Pub. Date: Sep. 7, 2006

(54) Speech synthesis method

(75) Inventors: Michio Aizawa, Yokohama-shi (JP); Yasuo Okutani, Kawasaki-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/355,300

(22) Filed: Feb. 15, 2006

(30) Foreign Application Priority Data
Mar. 1, 2005 (JP) 2005-055497

(51) Int. Cl. G10L 13/08

(52) U.S. Cl. 704/260

(57) ABSTRACT

In a phoneme-selection-type speech synthesis apparatus, sound quality when a suitable phoneme is not found is prevented from being deteriorated without changing an input sentence. A plurality of pieces of reading prosody information are obtained. The cost when an optimum phoneme sequence is selected with respect to each of the plurality of pieces of reading prosody information is calculated. Speech with respect to the reading prosody information in which the cost is minimized is synthesized.

### BACKGROUND OF THE INVENTION

1. Field of the Invention

The present invention relates to a speech synthesis method for connecting phonemes and synthesizing speech.

2. Description of the Related Art

Hitherto, speech synthesis apparatuses for, with respect to an input reading and prosody information, selecting suitable phonemes from a phoneme database and for connecting them and synthesizing speech have been proposed (see, for example, Japanese Patent Laid-Open No. 10-49193 (corresponding to U.S. Pat. No. 6,366,883)).

FIG. 5 illustrates such a speech synthesis apparatus. Here, for the sake of simplicity of description, one phoneme is used as the unit of phonemes. In addition, phonemes of any unit (unique/nonuniform phoneme length) may be used.

As an example, reading prosody information “K AA1 P IY / R EY1 SH IH OW” of “copy ratio”(“/” indicates the delimiting position of a word, and “1” indicates a stress position) is used.

Here, each phoneme of a phoneme sequence “K”, “AA”, “P”, “IY”, “R”, “EY”, “SH”, “IH”, and “OW” corresponding to a reading “K AA P IY R EY SH IH OW” is selected. Each phoneme has one or more candidates (for example, a plurality of phonemes “AA” are contained in a phoneme database).

In order to select, from a plurality of these candidates, a phoneme such that the entire phoneme sequence is optimized, the cost of a phoneme sequence is considered. For example, a phoneme cost indicating how much each phoneme matches the input reading prosody information and a connection cost indicating how much a connection with the adjacent phoneme is possible smoothly are used, and the sum of these costs is made to be the cost of the phoneme sequence.

In general, the smaller the cost of the phoneme sequence, the better the sound quality of the synthesized speech. However, when a phoneme having a large phoneme cost is locally contained or when the array of phonemes having a large connection cost is contained, the sound quality in the vicinity of the phoneme becomes very poor.

In Japanese Patent Laid-Open No. 2004-126205, in a portion where the cost is locally large, a method of replacing a character string of a portion to which the input sentence corresponds with a synonym, etc., is disclosed. The reading prosody information is changed by replacing the character string of the input sentence, and it becomes possible to eliminate a phoneme having a large cost locally.

However, in the method of Japanese Patent Laid-Open No. 2004-126205, since an input sentence is changed, a problem arises in that speech differing from that intended by a user is synthesized. In the present invention, sound quality is improved without changing an input sentence.

### SUMMARY OF THE INVENTION

In one aspect, the present invention provides a speech synthesis method including: an obtaining step of obtaining a plurality of pieces of reading prosody information; a calculation step of calculating a cost when an optimum phoneme sequence is selected with respect to each piece of the reading prosody information obtained in the obtaining step; and a speech synthesis step of synthesizing speech with respect to the reading prosody information selected based on the cost calculated in the calculation step.

In another aspect, the present invention provides a speech synthesis method including: an obtaining step of analyzing text information and obtaining a plurality of analysis results; a calculation step of calculating a cost when an optimum phoneme sequence is selected with respect to each of the analysis results obtained in the obtaining step; and a speech synthesis step of synthesizing speech for the analysis result selected based on the cost calculated in the calculation step.

Further features of the present invention will become apparent from the following description of exemplary embodiments with reference to the attached drawings.

### BRIEF DESCRIPTION OF THE DRAWINGS

FIG. 1 is a block diagram illustrating the configuration of an exemplary speech synthesis apparatus according to a first embodiment of the present invention.

FIG. 2 is a flowchart illustrating an exemplary processing procedure of the speech synthesis apparatus according to the first embodiment of the present invention.

FIG. 3 is a block diagram illustrating an exemplary configuration of a speech synthesis apparatus according to a second embodiment of the present invention.

FIG. 4 is a flowchart illustrating an exemplary processing procedure of the speech synthesis apparatus according to the second embodiment of the present invention.

FIG. 5 illustrates a conventional speech synthesis apparatus.

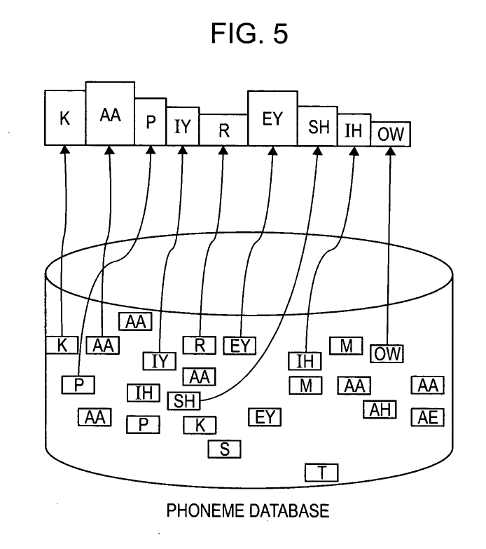

### DESCRIPTION OF THE EMBODIMENTS

Exemplary embodiments of the present invention will now be described below with reference to the drawings.

First Embodiment

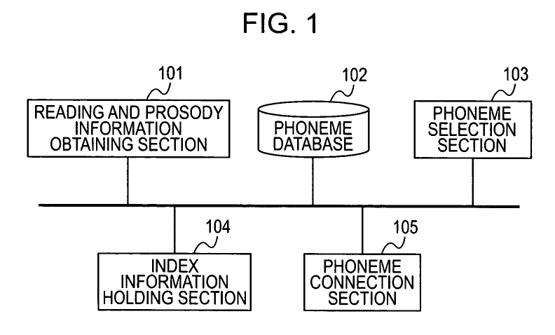

FIG. 1 is a block diagram illustrating the configuration of a speech synthesis apparatus according to a first embodiment of the present invention.

A reading prosody information obtaining section 101 obtains reading prosody information. Here, the reading prosody information denotes reading information and/or prosody information. A phoneme database 102 stores a plurality of registered phonemes. A phoneme selection section 103 selects an optimum phoneme sequence from the phoneme database 102.

An index information holding section 104 holds index information with respect to each phoneme of the selected phoneme sequence (information indicating which phoneme in the phoneme database). A phoneme sequence connection section 105 connects phonemes and synthesizes speech.

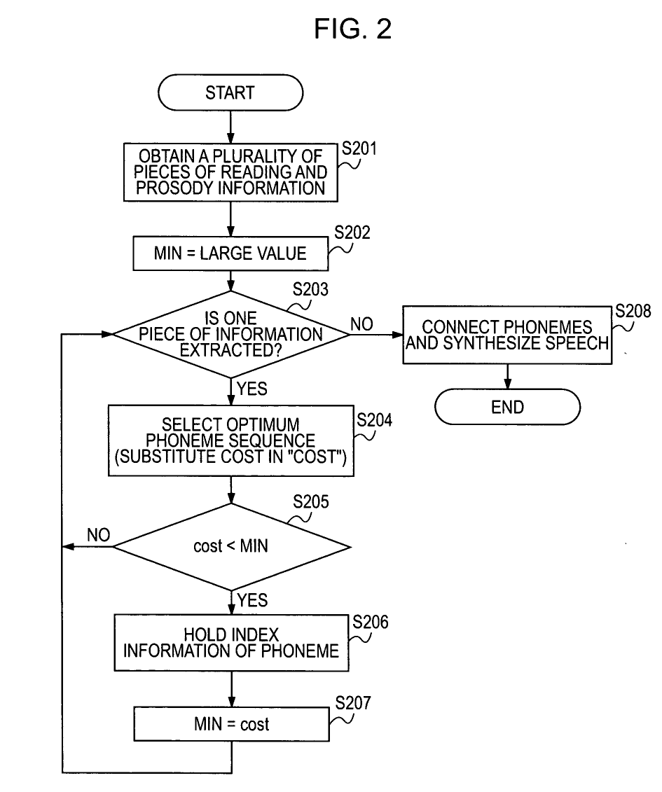

FIG. 2 is a flowchart illustrating an exemplary processing procedure of the speech synthesis apparatus according to the first embodiment of the present invention.

In S201, a plurality of pieces of reading prosody information are obtained. For example, two pieces of reading prosody information, that is, “K AA1 PIY / R EY1 SH IH OW” and “K AA1 P IY R EY SH IH OW”, are obtained.

Then, in S202, a sufficiently large value is set to a variable MIN.

In S203, one piece of reading prosody information that is not yet processed is extracted. When the information can be extracted, the process proceeds to S204. If the information cannot be extracted (all the reading prosody information has been processed), the process proceeds to S208.

In S204, with respect to the reading prosody information extracted in S203, an optimum (the cost is lowest) phoneme sequence is selected from the phoneme database, and the cost for the selected phoneme sequence is substituted in the variable cost.

A method for selecting an optimum phoneme sequence is disclosed in, for example, Japanese Patent Laid-Open No. 1998-49193. For the cost of the phoneme sequence, basically, the sum of the phoneme cost and the connection cost is used. In addition, when a phoneme cost or a connection cost of a fixed value or more is contained, a penalty may be added to the cost of the phoneme sequence.

In S205, the variable cost is compared with the value of the variable MIN. When the cost<MIN, the process proceeds to S206, and when the cost >=MIN, the process returns to S203.

In S206, index information for each phoneme of the phoneme sequence selected in S204 is held in an index information holding section 104. In S207, the value of the variable cost is substituted in the variable MIN. Processing then returns to S203.

In S208, a phoneme is extracted from the phoneme database on the basis of the index information of the index information holding section, and the phoneme is connected to synthesize speech. Processing then ends.

As a result of being configured in this manner, speech for a plurality of pieces of readings and prosody information having the lowest cost of the phoneme sequence is synthesized. As a consequence, it becomes possible to synthesize speech having a better sound quality. Furthermore, since the reading prosody information is not changed, it is possible to synthesize sentences intended by the user.

Second Embodiment

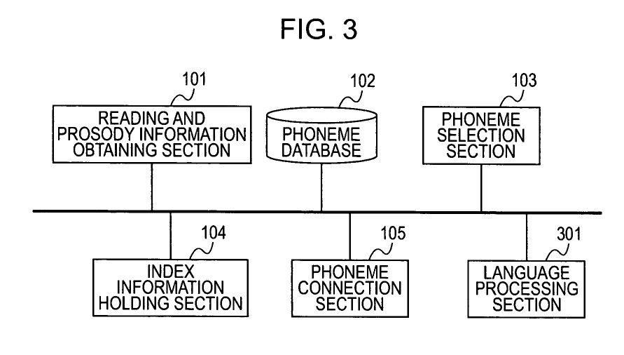

FIG. 3 is a block diagram illustrating an exemplary configuration of a speech synthesis apparatus according to a second embodiment of the present invention. Reference numerals 101 to 105 denote the same as those of FIG. 1 (described above), and descriptions thereof are not repeated here.

A language processing section 301 analyzes an input sentence and outputs a plurality of suitable reading prosody information.

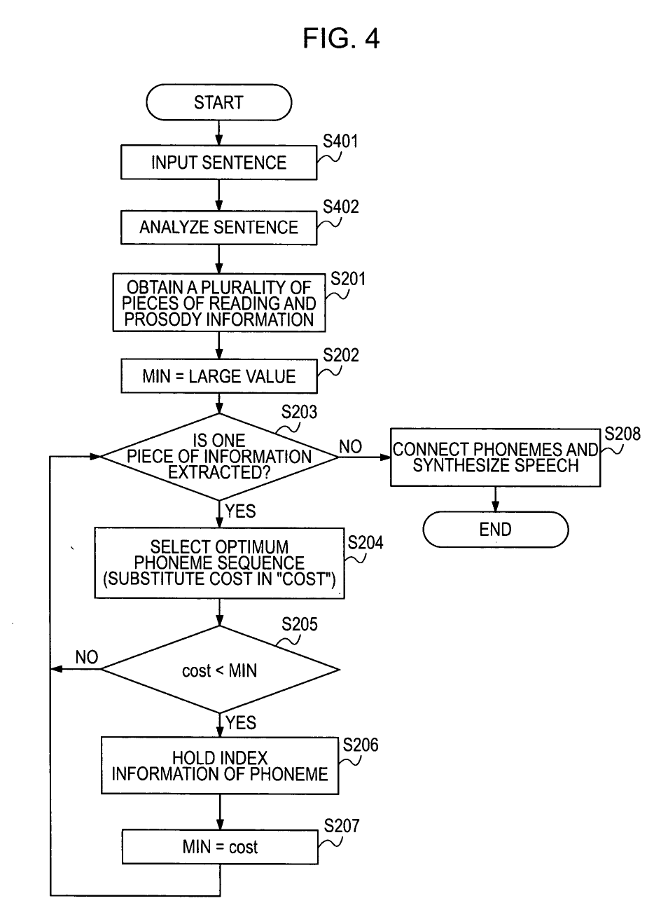

FIG. 4 illustrates the processing procedure of a speech synthesis apparatus according to this embodiment. In S201 to S208, the same processes as those of FIG. 2 (described above) are performed and descriptions thereof are not repeated here.

In S401, a sentence for which speech synthesis is performed is input. In S402, the sentence input in S401 is analyzed, and a plurality of pieces of reading prosody information are output. The plurality of the pieces of the output reading prosody information are obtained in S201.

For example, with respect to an input sentence “copy ratio”, reading prosody information “K AA1 P IY / R EY SH IH OW” and “K AA1 P IY / R EY1 SH IH OW” in which stress positions differ are output. In the former, the first stress in the second word is not placed. This becomes possible by the language processing section by outputting two kinds of results, that is, “a first stress is placed only in the first noun” and “a first stress is placed in both words”, with respect to a compound word of a noun+a noun.

Furthermore, for example, with respect to an input sentence “copy ratio”, “K AA1 PIY / R EY1 SH IH OW” and “K AA1 P IY R EY SH IH OW” in which delimiting positions of the words differ are output. This becomes possible by the language processing section by outputting two kinds of results, that is, “regarded as two words” and “regarded as one word”, with respect to a compound word of a noun+a noun.

Furthermore, for example, with respect to an input sentence “It's fine today.”, reading prosody information “IH1 T S / F AY1 N / T AH D EY1” and “IH1 T S /F AY1 N _ T AH D EY1” in which pause positions differ are output. Here, “_” indicates a pause. This becomes possible by the language processing section by outputting a plurality of pause positions.

Furthermore, for example, with respect to an input sentence “either”, reading prosody information “AY1 DH ER”and “IY1 DH ER” whose readings differ are output. This becomes possible by registering a plurality of readings in a dictionary for language processing. With respect to the word “either”, two readings, that is, “AY1 DH ER” and “IY1 DH ER”, are registered.

In the above-described examples, a description is given of a case in which two pieces of reading prosody information are output with respect to one input sentence. In addition, three or more pieces of reading prosody information may be output.

Furthermore, when, with respect to a certain input text, a cost may be calculated by the phoneme sequence connection section 105 and a portion having a large cost locally exists, that portion may be notified to the language processing section 301 and analysis results of the text in which the reading prosody information of that portion differs may be obtained.

The present invention can be achieved by supplying a storage medium storing software program code that achieves the functions of the above-described embodiments to a system or an apparatus and by enabling a computer (or a central processing unit (CPU) or a micro-processing unit (MPU)) of the system or apparatus to read the program code stored in the storage medium and to execute the program code.

In this case, the program code itself read out of the storage medium realizes the functions of the above-described embodiments and the storage medium storing the program code can realize the present invention.

Examples of storage media supplying program code include a flexible disk, a hard disk, an optical disk, a magneto-optical disk, a compact disk-read-only memory (CD-ROM), a CD-recordable (CD-R), a magnetic tape, a non-volatile memory card, and a ROM.

Also, in addition to the functions of the above-described embodiments being realized by the program code read out being executed on a computer, the functions of the above-described embodiments may be realized by the operating system (OS) running on the computer performing part or all of the actual processing based on instructions of the program code.

Moreover, the functions of the above-described embodiments may be realized by the program code read out from the storage medium being written to memory provided to a function expansion board inserted to the computer or a function expansion unit connected to the computer and thereafter, the CPU provided in that function expansion board or in that function expansion unit performs part or all of the actual processing based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2005-055497 filed Mar. 1, 2005, which is hereby incorporated by reference herein in its entirety.

What is claimed is:

1. A speech synthesis method comprising:
an obtaining step of obtaining a plurality of pieces of reading prosody information;
a calculation step of calculating a cost when an optimum phoneme sequence is selected with respect to each piece of the reading prosody information obtained in the obtaining step; and
a speech synthesis step of synthesizing speech with respect to the reading prosody information selected based on the cost calculated in the calculation step.

2. The speech synthesis method according to claim 1, wherein the speech synthesis step selects reading prosody information in which the cost is minimized and synthesizes speech with respect to the reading prosody information.

3. A computer-readable medium storing a control program comprising computer-executable instructions for enabling a computer to execute the speech synthesis method according to claim 1.

4. A speech synthesis method comprising:
an obtaining step of analyzing text information and obtaining a plurality of analysis results;
a calculation step of calculating a cost when an optimum phoneme sequence is selected with respect to each of the analysis results obtained in the obtaining step; and
a speech synthesis step of synthesizing speech for the analysis result selected based on the cost calculated in the calculation step.

5. The speech synthesis method according to claim 4, wherein the speech synthesis step selects an analysis result in which the cost is minimized and synthesizes speech with respect to the reading prosody information.

6. The speech synthesis method according to claim 4, wherein the obtaining step analyzes text information and obtains reading information and prosody information as analysis results; and
the speech synthesis step synthesizes speech with respect to reading information and prosody information in which the cost is minimized.

7. A computer-readable medium storing a control program comprising computer-executable instructions for enabling a computer to execute the speech synthesis method according to claim 4.

8. A speech synthesis apparatus comprising:
obtaining means for obtaining a plurality of pieces of reading prosody information;
calculation means for calculating a cost when an optimum phoneme sequence is calculated for each piece of the reading prosody information obtained by the obtaining means; and
speech synthesis means for synthesizing speech with respect to the reading prosody information selected based on the cost calculated by the calculation means.

9. The speech synthesis apparatus according to claim 8, wherein the speech synthesis means selects reading prosody information in which the cost is minimized and synthesizes speech with respect to the reading prosody information.

10. A speech synthesis apparatus comprising:
obtaining means for analyzing text information and obtaining a plurality of analysis results;
calculation means for calculating a cost when an optimum phoneme sequence obtained by the obtaining means is selected with respect to each analysis result; and
speech synthesis means for synthesizing speech with respect to an analysis result selected based on the cost calculated by the calculation means.

11. The speech synthesis apparatus according to claim 10, wherein the speech synthesis means selects an analysis result in which the cost is minimized and synthesizes speech with respect to the reading prosody information.

12. The speech synthesis apparatus according to claim 10, wherein the obtaining means analyzes text information and obtains reading information and prosody information as analysis results, and
the speech synthesis means synthesizes speech with respect to reading information and prosody information in which the cost is minimized.
